(19) United States
(12) Patent Application Publication
(10) Pub. No.: US 2014/0113160 A1
(43) Pub. Date: Apr. 24, 2014

(54) ARTICLES INCLUDING INTERMEDIATE LAYER AND METHODS OF FORMING

(71) Applicant: SEAGATE TECHNOLOGY LLC, Cupertino, CA (US)

(72) Inventors: Philip G. Pitcher, Shakopee, MN (US); John L. Brand, Burnsville, MN (US); Edwin F. Rejda, Bloomington, MN (US); Richard M. Fuller, Lake Elmo, MN (US)

(73) Assignee: SEAGATE TECHNOLOGY LLC, Cupertino, CA (US)

(21) Appl. No.: 13/798,469

(22) Filed: Mar. 13, 2013

Related U.S. Application Data
(60) Provisional application No. 61/715,519, filed on Oct. 18, 2012.
(60) Provisional application No. 61/728,306, filed on Nov. 20, 2012.

(51) Int. Cl. H01F 10/30; H01F 41/00; G11B 5/31

(52) U.S. Cl. CPC H01F 10/30; G11B 5/313; H01F 41/00
USPC 428/816; 428/336; 428/333; 427/127

(57) ABSTRACT

Articles that include a magnetic structure; an intermediate layer, the intermediate layer positioned on the magnetic structure, the intermediate layer having a thickness from about 3 Å to about 50 Å, the intermediate layer including a bottom interface layer, the bottom interface layer positioned adjacent the magnetic structure, the bottom interface layer including atoms of a metal bonded to atoms, compounds, or both of the magnetic structure; an interlayer, the interlayer positioned on the bottom interface layer, the interlayer including oxides of the metal; and a top interface layer, the top interface layer positioned adjacent the interlayer, the top interface layer including atoms of the metal, oxides of the metal, or some combination thereof bonded to atoms or compounds of the adjacent overcoat layer; and an overcoat layer, the overcoat layer positioned on the top interface layer of the intermediate layer.

### PRIORITY

This application claims priority to U.S. Provisional Application No. 61/715,519 entitled “ARTICLES INCLUDING INTERMEDIATE LAYER AND METHODS OF FORMING” having docket number 430.17508000 filed on Oct. 18, 2012; and U.S. Provisional Application No. 61/728,306 entitled “ARTICLES INCLUDING INTERMEDIATE LAYER AND METHODS OF FORMING” having docket number 430.17508001 filed on Nov. 20, 2012, the disclosures of which are incorporated herein by reference thereto.

### BACKGROUND

Various articles can often include different component layers. Component layers in proximity to each other can cause concerns based on the structural integrity of the article if the layers don't adhere well, based on the materials of one layer diffusing into the other, based on manufacturing methods used to form one or the other adjacent layers, or any combination thereof. Because of these, as well as other, issues a need remains to engineer intervening layers in order to address concerns that may be present in multilayer or multi-component articles.

### SUMMARY

Disclosed herein are articles that include a magnetic structure; an intermediate layer, the intermediate layer positioned on the magnetic structure, the intermediate layer having a thickness from about 3 Å to about 50 Å, the intermediate layer including a bottom interface layer, the bottom interface layer positioned adjacent the magnetic structure, the bottom interface layer including atoms of a metal bonded to atoms, compounds, or both of the magnetic structure; an interlayer, the interlayer positioned on the bottom interface layer, the interlayer including oxides of the metal; and a top interface layer, the top interface layer positioned adjacent the interlayer, the top interface layer including atoms of the metal, oxides of the metal, or some combination thereof bonded to atoms or compounds of the adjacent overcoat layer; and an overcoat layer, the overcoat layer positioned on the top interface layer of the intermediate layer.

Also disclosed are methods of forming articles, the methods including the steps of: obtaining a magnetic structure; forming a metal layer on at least a portion of the magnetic structure, the metal layer having a thickness from about a monolayer to about 50 Å; oxidizing at least a portion of the metal layer; and forming an overcoat layer.

Also disclosed herein are methods of forming an article, the methods including the steps of: obtaining a magnetic structure; forming a metal layer on said magnetic structure; and forming a metal oxide layer on said metal layer by forming metal atoms, oxidizing said metal atoms, and depositing said oxidized metal atoms on said metal layer to form a metal oxide layer.

These and various other features and advantages will be apparent from a reading of the following detailed description.

### BRIEF DESCRIPTION OF THE DRAWINGS

FIG. 1 is a cross section illustration of an article disclosed herein.

FIGS. 2A, 2B, 2C, and 2D are critical dimension scanning electron microscope (CDSEM) images of pegs that are described as totally deformed (Total) (FIG. 2A), partially deformed (Partial) (FIG. 2B), had corner deformation (Corners) (FIG. 2C) or had no deformation (None) (FIG. 2D).

FIGS. 3A, 3B, 3C, 3D, 3E, 3F, 3G, and 3H show CDSEM images of four representative comparative examples before and after annealing (After 300 C./30 mins/Air).

FIGS. 4A, 4B, 4C, 4D, 4E, 4F, 4G, and 4H show CDSEM images of four representative duplicates of Example 1 before and after annealing (After 300 C./30 mins/Air).

FIGS. 5A, 5B, 5C, 5D, 5E, 5F, 5G, and 5H show CDSEM images of four representative duplicates of Example 3 before and after annealing (After 300 C./30 mins/Air).

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range. All numbers recited herein for a particular property can also be utilized with all other numbers recited for that particular property in order to form ranges.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive. It should be noted that “top” and “bottom” (or other terms like “upper” and “lower”) are utilized strictly for relative descriptions and do not imply any overall orientation of the article in which the described element is located.

Disclosed herein are articles that include intermediate layers. Disclosed intermediate layers can be positioned between any layers, devices, or combinations thereof in order to engineer, control, or modify the interaction of the two layers, devices, or combinations thereof. Disclosed intermediate layers can also be utilized to engineer, control, or modify the processing or manufacture of adjacent layers, devices, or combinations thereof.

Disclosed intermediate layers can provide various benefits. Exemplary benefits can include, for example, enhancing the adherence of one layer to another, diminishing or eliminating diffusion of components from one layer (or device) to another, providing a surface that is compatible with later processing techniques, providing a surface that enhances mechanical properties of adjacent layers (or devices), other benefits not discussed herein, and combinations thereof.

Disclosed intermediate layers can be utilized in various applications. An example of an application in which disclosed intermediate layers can be useful can include articles and devices that include magnetic structures. Devices including magnetic structures can often include overcoats. Overcoats can be utilized along with magnetic structures in order to protect the magnetic structure from wear and tear, environmental affects, or combinations thereof for example. Overcoats, as the name would imply are often coated over the magnetic structure. Methods of forming overcoats, the overcoats themselves, or both can be sensitive to the nature of the underlying substrate surface. The “top” surface of magnetic structures, for example magnetic transducers, can include many different materials all of which may be conductive or insulating. Disclosed intermediate layers can provide a ubiquitous layer that can provide various beneficial properties, such as promoting adhesion, promoting consistent overcoat properties over the surface, providing a non-electrically shunting layer (if necessary) over the magnetic structures, or some combination thereof. Disclosed intermediate layers can specifically be useful when surface sub-plantation process technologies will be utilized for deposition of further layers, for example the overcoat layer. Disclosed intermediate layers can therefore function as diffusion barriers, adherence layers, electrically insulating layers, set-up layers for layers formed thereon, or any combinations thereof.

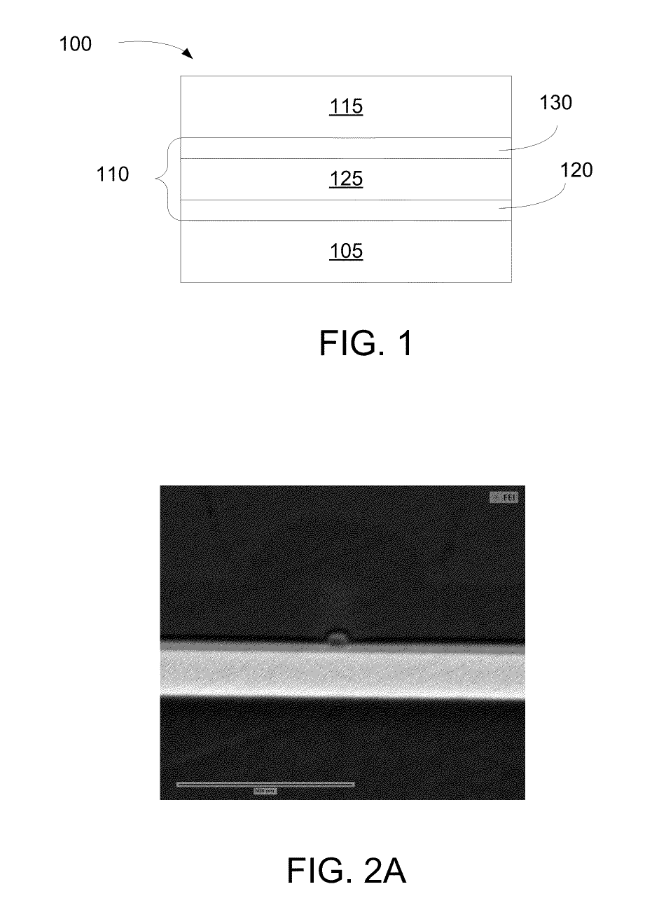

FIG. 1 illustrates a cross section of an exemplary disclosed article. The article 100 can include a magnetic structure 105, an intermediate layer 110, and an overcoat layer 115. The intermediate layer is generally positioned adjacent to, on, on top of, or above the magnetic structure. It should be noted that the intermediate layer can be positioned adjacent to, on, on top of, or above a portion of the magnetic structure or the entire magnetic structure. The overcoat layer is generally positioned adjacent to, on, on top of, or above at least a portion of the intermediate layer.

The magnetic structure 105 can include any article or device that has a magnetic component or layer. In some embodiments, the magnetic structure can include magnetic media or a magnetic transducer for example. In some embodiments, the magnetic structure can include a magnetic transducer. In some embodiments, the magnetic structure can include both a magnetic reader and a magnetic writer. In such embodiments, the interlay can be positioned adjacent to, on, on top of, or above the magnetic reader, the magnetic writer, or both. Magnetic structures can also include components, devices, or layers that are not magnetic in nature or function. Exemplary types of additional components can include, for example, optical components such as optical waveguides, lasers, near field transducers (NFTs), or combinations thereof. Exemplary magnetic structures can include heat assisted magnetic recording (HAMR) heads, perpendicular recording heads, and longitudinal recording heads for example.

Magnetic structures can include one or more than one type of material. In some embodiments, the magnetic structures can include one or more than one type of atom, compound, or combination thereof. In some embodiments, where the magnetic structure includes both a magnetic reader and a magnetic writer, the magnetic structure can include FeCo, NiFe, Cr, AlOₓ, TaOₓ, SiOₓ, Au, or any combination thereof.

Exemplary disclosed articles also include an intermediate layer 110, as seen in FIG. 1. In some embodiments, a disclosed intermediate layer can be relatively thin. In some embodiments, a disclosed intermediate layer can have a thickness from 3 Å to 50 Å. In some embodiments, a disclosed intermediate layer can have a thickness from 3 Å to 20 Å. The intermediate layer, as a whole can have various properties. Disclosed intermediate layers can have one, more than one, none of the properties discussed herein, and/or properties not discussed herein.

The intermediate layer can function as a diffusion barrier. An intermediate layer functioning as a diffusion barrier can decrease or eliminate diffusion of atoms or compounds from one layer to another. For example, an intermediate layer functioning as a diffusion barrier can decrease or eliminate atoms or compounds from a magnetic structure diffusing into an overcoat layer, atoms or compounds from an overcoat layer diffusing into a magnetic structure, or a combination thereof. The intermediate layer or a portion thereof can also function to decrease or eliminate atoms or compounds of the intermediate layer itself from diffusing into adjacent structures, such as the magnetic structure, the overcoat layer, or both.

The intermediate layer can also function to increase or enhance the adherence of one layer or structure to another. For example, an intermediate layer can enhance the adherence and therefore mechanical strength or integrity of an overcoat to a magnetic structure. Disclosed intermediate layers can function to increase or enhance the adherence of a layer or structure to another even in circumstances where the layer, the structure, or both include more than one material. For example, disclosed intermediate layers can function to increase or enhance the adherence to oxide materials, metallic materials, or both. In some embodiments, the different components of the intermediate layer can function to increase or enhance the adherence to layers or structures above and below the intermediate layer.

The intermediate layer can also function to provide a surface that is compatible with or amenable to various types of processes. For example, an intermediate layer can provide a surface that is amenable to different kinds of deposition techniques. Specific examples of deposition techniques for which disclosed intermediate layers can provide advantageous surfaces are surface sub-plantation techniques. Exemplary surface sub-plantation techniques can be found, for example, in U.S. patent application Ser. Nos. 13/440,068; 13/440,071; and 13/440,073.

The intermediate layer can also function to provide enhanced or advantageous properties to layers that are formed thereon. For example, when disclosed intermediate layers are utilized as a surface upon which surface sub-plantation techniques are being used to form a layer, the layer so formed can have advantageous properties. Examples of advantageous properties can include, for example mechanical properties such as prevention of mechanical delamination (often described as “crinking”, “buckling”, or “wrinkling”).

The intermediate layer can also function to provide desired electrical properties. In some embodiments, the intermediate layer can be electrically non-conductive. For some applications it can be advantageous to have the intermediate layer be electrically non-conductive. Such applications can include magnetic structures that include magnetic readers. In embodiments where the intermediate layer covers at least the magnetic reader of a magnetic structure, it can be advantageous that the intermediate layer not be electrically conductive. If the intermediate layer is electrically conductive in this situation, the intermediate layer can act as a shunt and short out the magnetic reader. In some embodiments that include a perpendicular magnetic recording head as a magnetic structure, the intermediate layer can be electrically non-conductive. In embodiments where it is advantageous for the intermediate layer to be electrically non-conductive, electrically non-conductive implies that the intermediate layer is resistive enough that the magnetic component(s) of the magnetic structure have the operational characteristics enabled.

The intermediate layer 110 can include a bottom interface layer 120, an interlayer 125, and a top interface layer 130. It should be noted that the representation of different thicknesses in FIG. 1 are for example only, and should not be taken as an indication of thicknesses of the various layers. The bottom interface layer is generally positioned adjacent to, directly adjacent to, or in contact with the magnetic structure. The interlayer is positioned adjacent to, directly adjacent to, in contact with, or on the bottom interface layer and is generally positioned between the bottom interface layer and the top interface layer. The top interface layer is generally positioned adjacent to, directly adjacent to, in contact with, or directly underneath the overcoat layer. The intermediate layer can also be described as a sandwich structure in which the interlayer is between the bottom interface layer and the top interface layer.

As a whole, the intermediate layer includes atoms of a metal or metals and oxides of the metal or metals. The particular locations within the intermediate layer where atoms of a metal or metals and oxides of the metal or metals are located may provide the various advantageous properties of the intermediate layer and will be discussed herein.

The bottom interface layer includes atoms of a single or multiple metals. Stated another way, the bottom interface layer includes metal atoms. The metal atoms of the bottom interface layer may be described as being bonded to the top portion or top layer of the magnetic structure. Stated another way, the metal atoms of the bottom interface layer may be described as being bonded to atoms, compounds, or both, of the magnetic structure. In some embodiments where the magnetic structure includes metal atoms (and optionally additional metals, compounds or both), the metal atoms of the bottom interface layer may be bonded to the metal atoms in the magnetic structure. In some embodiments where the magnetic structure includes compounds, such as oxides (and optionally additional compounds, metals, or both), the metal atoms of the bottom interface layer may be bonded to the oxides in the magnetic structure.

It is thought, but not relied upon that the bottom interface layer strongly contributes to the ability of the intermediate layer's ability to increase or enhance adhesion of one layer or structure to another. In some embodiments, the bottom interface layer has a thickness that renders it electrically non-conductive. In some embodiments, where it is desired that the intermediate layer as a whole is electrically non-conductive, the bottom interface layer can be of a thickness that renders it electrically non-conductive. In some embodiments, the bottom interface layer can have a thickness as thin as a partial or full monolayer of atoms. In some embodiments, the bottom interface layer can have a thickness as thin as a monolayer or partial monolayer of atoms. In some embodiments, the bottom interface layer can have a thickness as thin as 2 Å. In some embodiments, the bottom interface layer can have a thickness as thin as 3 Å. In some embodiments, the bottom interface layer can have a thickness as thin as 5 Å. In some embodiments, the bottom interface layer can have a thickness as thick as 30 Å. In some embodiments, the bottom interface layer can have a thickness as thick as 20 Å. In some embodiments, the bottom interface layer can have a thickness as thick as 15 Å.

Disclosed intermediate layers also include an interlayer which includes oxides of the metal. In some embodiments, the oxides of the metal, or metal oxides can function to decrease or eliminate diffusion of atoms across the interlayer. As such, the interlayer can contribute to the ability of the intermediate layer to act as a diffusion barrier. The metal oxides of the interlayer can function to decrease or eliminate diffusion of metal atoms in the intermediate layer, atoms or compounds from the magnetic structure, overcoat, or both from diffusing through the interlayer. The interlayer or the metal oxides making up the interlayer can also have a relatively low permeability with respect to other compounds, for example it can have a low permeability to oxygen or other gaseous compounds.

Disclosed intermediate layers also include a top interface layer. Exemplary top interface layers can include atoms of the metal (or optionally metals), oxides of the metal (or optionally metals), or some combination thereof. Exemplary top interface layers generally include metal atoms or oxides of metal atoms bonded to atoms or compounds of the adjacent overcoat layer. The top interface layer may, thereby contribute to the ability of the intermediate layer to act to enhance or increase the adherence of one layer or structure to another (in this case assist in the adherence of the overcoat layer). Additionally, the top interface layer may, but need not, contribute to the ability of the intermediate layer to act as a diffusion barrier.

As discussed above, the intermediate layer includes atoms of a metal (or metals) and oxides of the metal or metals. In some embodiments, an intermediate layer includes only one kind of metal atoms, and therefore only one kind of metal oxides (disregarding the ability to have different oxidation states and therefore different number of oxygen atoms in a metal oxide). In some embodiments, an intermediate layer includes more than one kind of metal atoms, and therefore more than one kind of metal oxides (as well as the ability to have different oxidation states and therefore different number of oxygen atoms in a metal oxide).

The particular metal utilized for disclosed intermediate layers can be chosen based, at least in part on desired properties of the intermediate layer. In some embodiments, a particular metal is chosen based on its affinity for oxygen. In some embodiments, a metal that is chosen for use in an intermediate layer should have a relatively low affinity for oxygen. Such a metal may, but need not have self-limiting, with respect to the extent of oxidation, oxide growth. The appropriate level of oxygen affinity, which causes the self-limiting effect, may allow the formation of the multilayer structure of the intermediate layer, or more specifically, maintains the un-oxidized metal of the bottom interface layer that contributes to the ability of the intermediate layer to simultaneously enhance adherence and prevent diffusion.

In some embodiments, a particular metal is chosen based, at least in part, on the ability of the oxide (or oxides) of the metal to stop or limit the permeability of oxygen. Such a property can be useful in order to allow the formation of the multilayer structure of the intermediate layer, or more specifically, maintains the un-oxidized metal of the bottom interface layer that contributes to the ability of the intermediate layer to simultaneously enhance adherence and prevent diffusion.

In some embodiments, a particular metal is chosen based, at least in part, on its ability to adhere to, or covalently bond via the bottom interface layer, with atoms or compounds present in the underlying magnetic structure. The relevant materials in the magnetic structure can depend at least in part on the identity and function of the magnetic structure. In some embodiments, where the magnetic structure is a magnetic transducer, the magnetic structure can include FeCo, NiFe, Cr, AlOₓ, TaOₓ, SiOₓ, Au, or combinations thereof. In such an embodiment then, the particular metal could be chosen based on an ability to bond to one or more of those materials.

In some embodiments, a particular metal is chosen based, at least in part, on its effectiveness as a substrate for additional processing that may be occurring on the article. For example, the particular metal may be chosen, at least in part, on its effectiveness as a substrate for depositing the overcoat layer. In some embodiments, the overcoat layer (or other layers) may be formed using surface sub-plantation techniques, for example. In such embodiments, the particular metal chosen could advantageously be a material that provides an effective surface upon which to form an overcoat layer using surface sub-plantation techniques.

In some embodiments, a particular metal is chosen based, at least in part, on the ability of it to advantageously affect at least one property of a layer that is being formed over or on it. For example, the particular metal may be chosen, at least in part, on its ability to positively affect an overcoat layer deposited thereon. In some embodiments, the overcoat layer (or other layers) may be formed using surface sub-plantation techniques, for example. In such embodiments, the particular metal chosen could advantageously be a material that has an ability to positively affect mechanical attributes of the overcoat layer formed thereon. Examples of advantageous properties can include, for example mechanical properties such as prevention of mechanical delamination (often described as “crinking”, “buckling”, or “wrinkling”) of the overlying overcoat layer.

In some embodiments, an intermediate layer can include chromium (Cr), aluminum (Al), or a combination thereof (for example perhaps in multiple layers or an alloy). In some embodiments, an intermediate layer can include chromium. In such an embodiment, a bottom interface layer would include chromium (Cr) atoms, an interlayer would include chromium oxide (CrOₓ), and a top interface layer could include Cr, CrOₓ, or a combination thereof. Chromium can be an advantageous metal to include in an intermediate layer because it has a relatively low affinity for oxygen, adheres well to various atoms and/or compounds including specifically gold (Au), CrOₓ has a relatively low permeability to oxygen thereby making the oxidation self-limiting, provides a good substrate upon which to utilize surface sub-plantation techniques, and demonstrates advantageous properties in overlying overcoats such as anti-wrinkling behavior.

Articles disclosed herein also include an overcoat layer 115. The overcoat layer is positioned adjacent to, directly adjacent to, on or directly on the intermediate layer, or more specifically the top interface layer of the intermediate layer. The overcoat layer can generally include a material that provides protection to the article. In some embodiments, the overcoat layer can include carbon. In some embodiments, the overcoat layer, such as carbon can be formed on the top interface layer of the intermediate layer using various techniques, including for example surface sub-plantation techniques. Methods of forming the overcoat layer include surface sub-plantation and Filtered Cathodic Arc (FCA) techniques including pulsed FCA (pFCA) methods. Exemplary surface sub-plantation techniques can be found, for example, in U.S. patent application Ser. Nos. 13/440,068; 13/440,071; and 13/440,073.

Articles disclosed herein can be utilized in various applications. In some embodiments, disclosed articles can be utilized for reading and writing of data onto a magnetic media. In some embodiments, disclosed articles can be used as magnetic media. In some embodiments, disclosed articles can be utilized for reading and writing data onto magnetic media using heat assisted magnetic recording (HAMR), and perpendicular recording head devices for example.

Also disclosed herein are methods of forming articles. Exemplary methods can include various steps undertaken in various orders. A first step in some embodiments of disclosed methods can include a step of obtaining a magnetic structure. The obtained magnetic structure can have characteristics such as those discussed above. The step of obtaining a magnetic structure can be accomplished by forming a magnetic structure or by obtaining an already formed magnetic structure via purchase or otherwise.

Disclosed embodiments of methods also include a step of forming a metal layer. The metal layer can generally be formed on at least a portion of the magnetic structure. The metal can have characteristics and/or can be chosen as discussed above with respect to the metal in the intermediate layer. In some embodiments, the metal layer can have a thickness in the range from a monolayer or slightly less to 50 Å. In some embodiments, the metal layer can have a thickness in the range from a monolayer to 30 Å. In some embodiments, the metal layer can have a thickness in the range from a monolayer to 20 Å.

Disclosed embodiments of methods also include steps of oxidizing at least a portion of the metal layer and depositing an overcoat layer. In some embodiments, the step of oxidizing a portion of the metal layer is undertaken before the overcoat layer is deposited and in some embodiments, the step of oxidizing a portion of the metal layer is undertaken after the overcoat layer is deposited. Methods in which a portion of the metal layer is oxidized before the overcoat layer is deposited are referred to herein as ex-situ. Methods in which the overcoat layer is deposited before a portion of the metal layer is oxidized are referred to herein as in-situ.

In-situ methods form a metal layer on the magnetic structure, deposit an overcoat layer and then at least a portion of the metal layer is oxidized. It should be noted that some of the metal layer could be getting oxidized before the overcoat layer is deposited or while the overcoat layer is deposited, but such oxidation is passive in nature. In-situ methods utilize or rely on oxygen diffusion through the deposited overcoat or through an underlying layer, for example an underlying oxide layer, in order to oxidize the portion of the metal layer. It should be noted however that even if oxygen diffuses from an underlying layer, the metal atoms bonded to the underlying atoms, compounds, or both from the magnetic structure remain bonded, thereby forming and maintain the bottom interface layer.

Formation or deposition of an overcoat layer can be accomplished using various deposition techniques. In some embodiments, an overcoat layer can be deposited using surface sub-plantation techniques. Exemplary surface sub-plantation techniques can be found, for example, in U.S. patent application Ser. Nos. 13/440,068; 13/440,071; and 13/440,073, the disclosures of which are incorporated herein by reference thereto.

Ex-situ methods form a metal layer on the magnetic structure, oxidize at least a portion of the metal layer and then deposit or form an overcoat layer. Oxidation of at least a portion of the metal layer can be accomplished using various techniques. Exemplary ways in which a portion of the metal layer can be oxidized can include passive oxidation in oxygen containing, ambient room temperature conditions; by annealing in an oxygen containing high temperature condition; by exposure to a thermalized oxygen atom beam or oxygen ion beam (or ion beam containing oxygen ions); or combinations thereof.

In some embodiments, a metal layer can be formed that is relatively thin, i.e. at least a monolayer thick; and then at least a portion of the metal layer can be oxidized. It should be noted however that even if a portion of the very thin metal layer (for example a monolayer type of thickness) is oxidized, the metal atoms bonded to the underlying atoms, compounds, or both from the magnetic structure remain bonded, thereby forming and maintaining the bottom interface layer. In some embodiments, the steps of forming a metal layer and oxidizing at least a portion of the metal layer can be repeated. In some embodiments, a relatively thin metal layer (for example a monolayer type of thickness) is formed, at least a portion of the metal layer is oxidized, another metal layer (either a monolayer type of thickness or a greater thickness) is formed, and at least a portion of the metal layer is oxidized. In some embodiments, structures (for example a structure including bottom interface layer and an interlayer as discussed above) may be built up from multilayers produced through sequential metal layer formation of ultrathin metal layers which can be subsequently oxidized by a self-limiting oxidation effect (they could for example be oxidized by the oxygen present in an ambient, room temperature environment). The multilayer can be produced in this fashion until the desired thickness is reached.

In some embodiments, a final metal layer can be deposited without a final oxidation step. Such a final metal layer can be utilized along with the step of forming the overcoat layer (for example via surface sub-plantation techniques) in order to form a top interface layer in which at least some metal atoms or metal oxides are bonded to atoms or compounds within the overcoat layer.

Also disclosed here are additional methods of forming articles. Such methods can include steps of obtaining a magnetic structure, as was discussed above. This can be followed by a step of forming a metal layer on the magnetic structure. The metal can have characteristics and/or can be chosen as discussed above with respect to the metal in the intermediate layer. In some embodiments, the metal layer can have a thickness in the range from a monolayer or slightly less to 3 Å. This metal layer can ultimately form a bottom interface layer of an intermediate layer such as was discussed above.

The next step in such a method includes a simultaneous step of forming a metal oxide layer in which metal atoms are formed and oxidized and then the metal oxides are deposited on the previously formed metal layer.

Methods of depositing the intermediate layer in this fashion can include, but are not restricted too, Ion Beam sputter Deposition (IBD), PVD (e.g. magnetron sputtering, evaporation), low energy surface sub-plantation (SSP), atomic layer deposition (ALD) etc. As a more specific example, in IBD particles forming the intermediate layer can be sputtered from a target by an ion beam, the geometry of the ion gun and target assembly can be arranged such that the sputtered particles can be directed towards the plane of deposition. To deposit the initial metal layer, i.e., a pure metal film, a beam of inert gas atoms can be used in the sputtering process of a pure metal target. Subsequent deposition of oxide material can be produced by incorporation of oxygen into the ion beam or sputtering from an oxide target after deposition of the bottom interface layer. A particularly beneficial method to produce oxidation after deposition of the bottom interfacial layer may be through the use of a low energy or thermalized oxygen atom beam incident at the plane of deposition. This approach could be used post metal deposition or simultaneously with an incident metal flux to produce an oxide layer. Similar methods could also be utilized to form the top interface layer. Careful control of deposition parameters could be utilized to minimize or avoid mixing of atoms at the interfacial regions. Alternatively, oxidation can be achieved by exposure to an oxygen containing ambient environment either at room temperature or through thermal annealing. Sequential metal deposition and oxidation steps may also be used to produce the intermediate layer structure.

Any of the disclosed types of methods above can also include a step or steps of forming an overcoat layer, either before or after the intermediate layer has been formed, depending on the method being considered. Methods of forming the overcoat layer, in any type of method disclosed herein can include, for example, surface sub-plantation and Filtered Cathodic Arc (FCA) techniques including pulsed FCA (pFCA) methods. Exemplary surface sub-plantation techniques can be found, for example, in U.S. patent application Ser. Nos. 13/440,068; 13/440,071; and 13/440,073.

The present disclosure is illustrated by the following examples. It is to be understood that the particular examples, assumptions, modeling, and procedures are to be interpreted broadly in accordance with the scope and spirit of the disclosure as set forth herein.

### EXAMPLES

On an AlTiC wafer, the following structure was deposited via physical vapor deposition: a 5 Å Zr seed layer, a 25 nm high×45 nm wide gold peg, and a 5 Å Zr cap layer. This was then followed by a dielectric overcoat layer. This wafer was then lapped to a peg length from 0 nm to 100 nm. After lapping, an overcoat was deposited to the ABS. The comparative example had a 35 Å ion beam deposited (IBD) TaOx film followed by a 22 Å Filtered Cathodic Arc Carbon film. Example 1 had a 8 Å IBD Cr film followed by a 22 Å IBD carbon film. Example 2 had a 16 Å IBD Cr film followed by a 22 Å IBD carbon film. Example 3 had two successive depositions of a 4 Å IBD Cr film, each with a post-deposition oxidation in air for an hour, followed by a 22 Å IBD carbon film. Example 4 had four successive depositions of a 4 Å IBD Cr film, each with a post-deposition oxidation in air for an hour, followed by a 22 Å IBD carbon film.

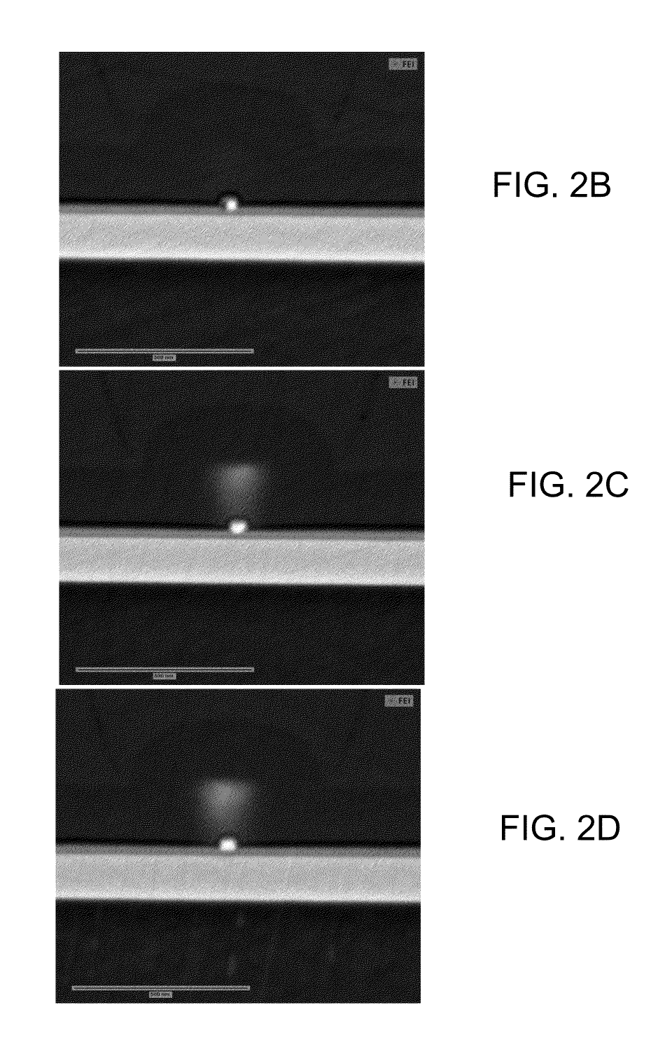

The samples were then subjected to a thermal stress test that included annealing at about 300° C. for about 30 minutes in air. FIGS. 2A, 2B, 2C, and 2D are critical dimension scanning electron microscope (CDSEM) images of pegs that are described as totally deformed (Total) (FIG. 2A), partially deformed (Partial) (FIG. 2B), had corner deformation (Corners) (FIG. 2C) or had no deformation (None) (FIG. 2D). It should be noted that pegs that are totally deformed, or recessed can disappear from view on the CDSEM images as they blend into the surrounding structure, leaving only the void where they existed. Various amounts of the comparative example, Example 1, Example 2, Example 3, and Example 4 fabricated as discussed above were subjected to this test.

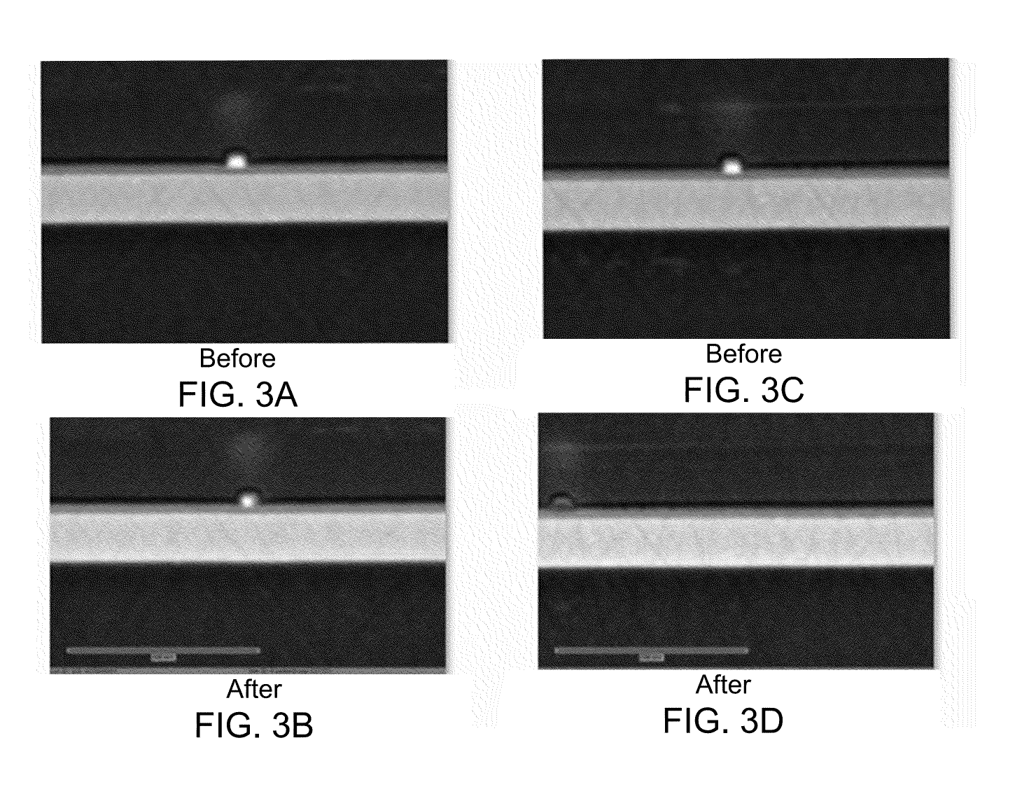

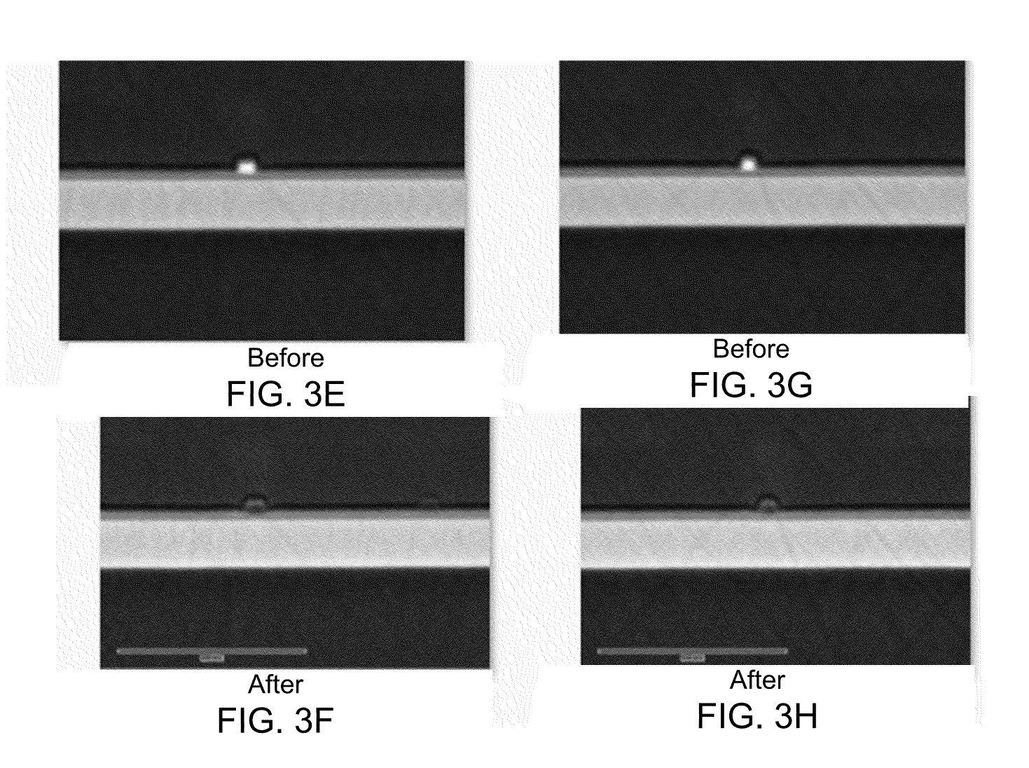

FIGS. 3A, 3B, 3C, 3D, 3E, 3F, 3G, and 3H show CDSEM images of four representative comparative examples before and after annealing (After 300 C./30 mins/Air). The comparative example seen in FIGS. 3A (before) and 3B (after) showed significant rounding of the peg; and FIGS. 3C (before) and 3D (after); FIGS. 3E (before) and 3F (after); and FIGS. 3G (before) and 3H (after) showed complete recession of the peg.

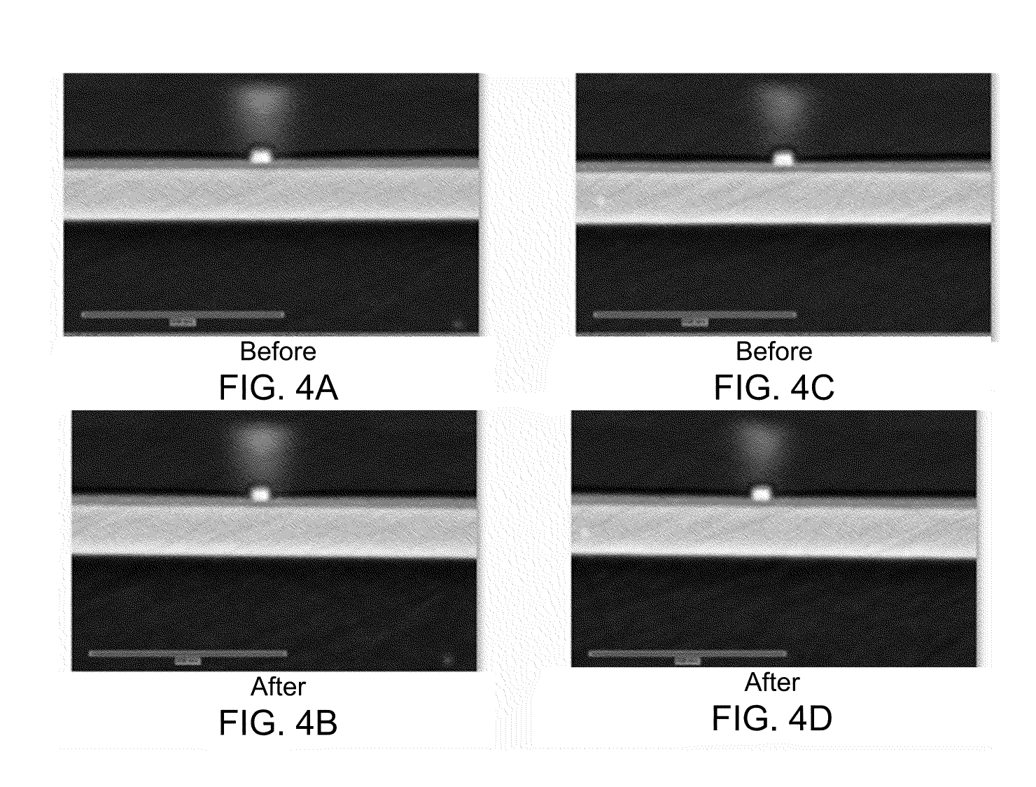

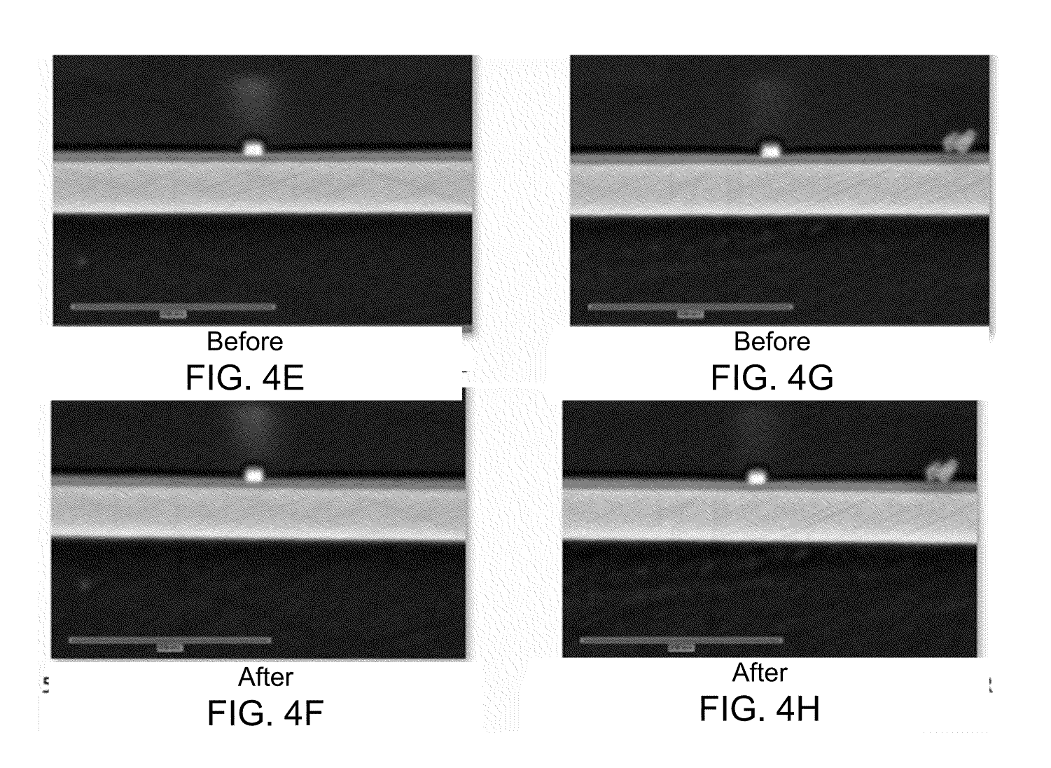

FIGS. 4A, 4B, 4C, 4D, 4E, 4F, 4G, and 4H show CDSEM images of four representative duplicates of Example 1 before and after annealing (After 300 C./30 mins/Air). All four of the Example 1 pegs seen here in FIGS. 4A (before) and FIG. 4B (after); FIGS. 4C (before) and 4D (after); FIGS. 4E (before) and 4F (after); and FIGS. 4G (before) and 4H (after) showed no deformation.

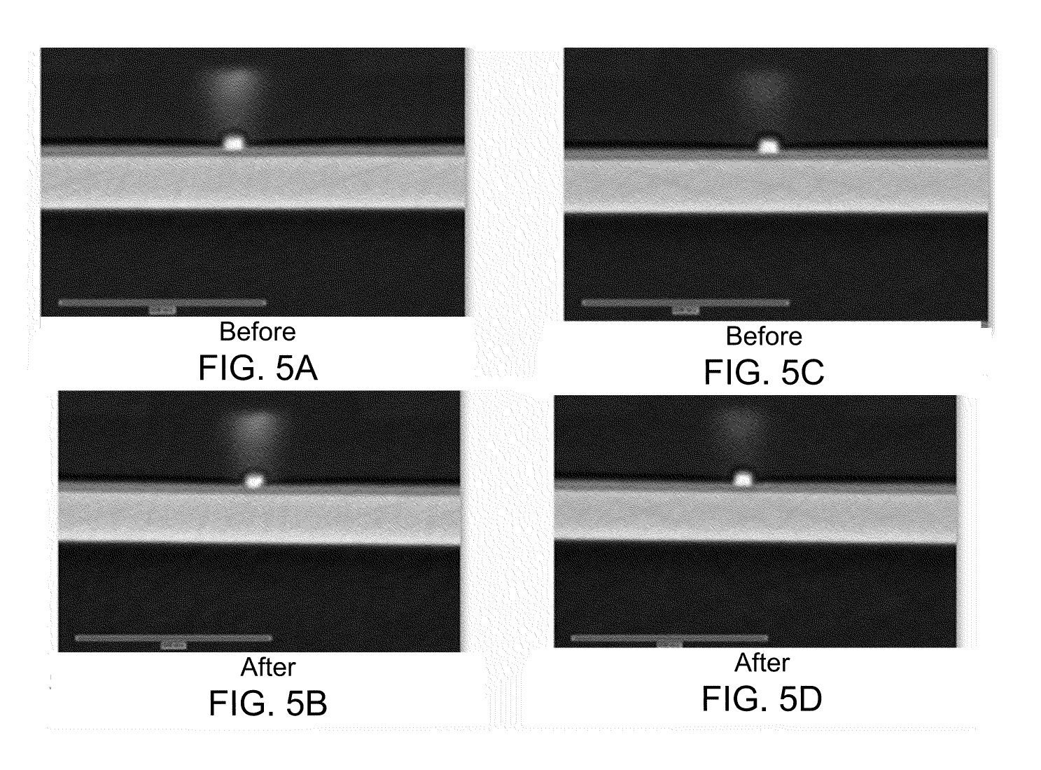

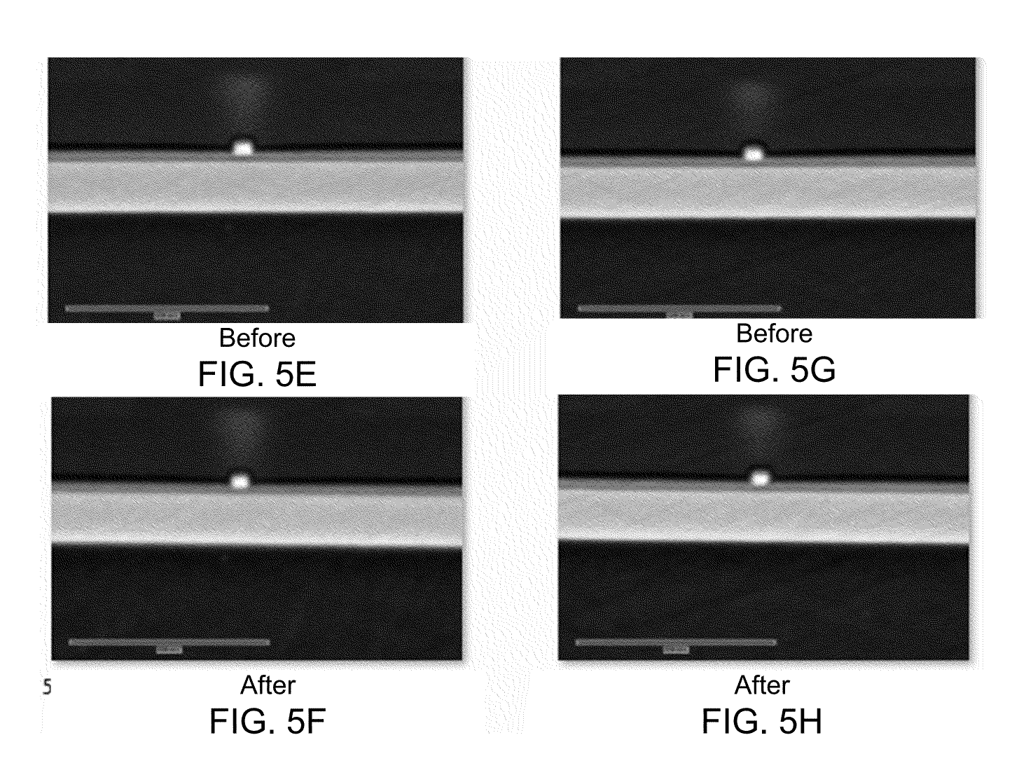

FIGS. 5A, 5B, 5C, 5D, 5E, 5F, 5G, and 5H show CDSEM images of four representative duplicates of Example 3 before and after annealing (After 300 C./30 mins/Air). All four of the Example 3 pegs seen here in FIGS. 5A (before) and FIG. 5B (after); FIGS. 5C (before) and 5D (after); FIGS. 5E (before) and 5F (after); and FIGS. 5G (before) and 5H (after) showed no deformation.

Table I below shows a summary of deformation data for the comparative example and Examples 1-4.

TABLE I

| Example | Peg Recession Area at ABS (% of Sliders) | | | | |
|---|---|---|---|---|---|
| Number | Total | Partial | Corners | None | # of Sliders |
| Comparative | 79 | 10 | 3 | 7 | 29 |
| Example 1 | 0 | 9 | 59 | 33 | 46 |
| Example 2 | 0 | 2 | 29 | 69 | 48 |
| Example 3 | 16 | 24 | 46 | 14 | 50 |
| Example 4 | 0 | 21 | 44 | 35 | 43 |

Thus, embodiments of articles including intermediate layer and methods of forming are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. An article comprising:
a magnetic structure;
an intermediate layer, the intermediate layer positioned on the magnetic structure, the intermediate layer having a thickness from about 3 Å to about 50 Å, the intermediate layer comprising:
a bottom interface layer, the bottom interface layer positioned adjacent the magnetic structure, the bottom interface layer comprising atoms of a metal bonded to atoms, compounds, or both of the magnetic structure;
an interlayer, the interlayer positioned on the bottom interface layer, the interlayer comprising oxides of the metal; and
a top interface layer, the top interface layer positioned adjacent the interlayer, the top interface layer comprising atoms of the metal, oxides of the metal, or some combination thereof bonded to atoms or compounds of the adjacent overcoat layer; and
an overcoat layer, the overcoat layer positioned on the top interface layer of the intermediate layer.

2. The article according to claim 1, wherein the magnetic structure comprises a magnetic transducer.

3. The article according to claim 2, wherein the magnetic transducer comprises a magnetic reader and a magnetic writer, and the interlayer is positioned over the magnetic reader, the magnetic writer, or both of the magnetic transducer.

4. The article according to claim 3, wherein the atoms or compounds of the magnetic transducer comprise FeCo, NiFe, Cr, AlOₓ, TaOₓ, SiOₓ, Au, or some combination thereof.

5. The article according to claim 1, wherein the intermediate layer is electrically non-conductive.

6. The article according to claim 5, wherein the bottom interface layer of the intermediate layer is of a thickness that renders the bottom interface layer non-conductive.

7. The article according to claim 6, wherein the bottom interface layer has a thickness from about a monolayer of the atoms of the metal to about 30 Å.

8. The article according to claim 1, wherein the metal in the intermediate layer is selected from chromium, aluminum, or a combination thereof.

9. The article according to claim 1, wherein the metal in the intermediate layer is chromium.

10. The article according to claim 1, wherein the intermediate layer has a thickness of about 3 Å to about 20 Å.

11. A method of forming an article, the method comprising the steps of:
obtaining a magnetic structure;
forming a metal layer on at least a portion of the magnetic structure, the metal layer having a thickness from about a monolayer to about 50 Å;
oxidizing at least a portion of the metal layer; and
forming an overcoat layer.

12. The method of claim 11, wherein the overcoat layer is formed on the metal layer before the portion of the metal layer is oxidized.

13. The method of claim 12, wherein the portion of the metal layer is oxidized by oxygen that diffuses through the overcoat layer, oxygen present in an underlying layer, or some combination thereof.

14. The method of claim 11, wherein the metal layer is chromium.

15. The method of claim 11, wherein the overcoat layer is formed after the portion of the metal layer is oxidized.

16. The method of claim 15, wherein the steps of forming a metal layer and oxidizing the metal layer are repeated at least two times.

17. The method of claim 15, wherein the portion of the metal layer is oxidized by passive oxidation in oxygen containing, ambient room temperature conditions; by annealing in an oxygen containing high temperature condition; by exposure to a thermalized oxygen atom beam or oxygen ion beam; or combinations thereof.

18. A method of forming an article, the method comprising the steps of:
obtaining a magnetic structure;
forming a metal layer on said magnetic structure; and
forming a metal oxide layer on said metal layer by forming metal atoms, oxidizing said metal atoms, and depositing said oxidized metal atoms on said metal layer to form a metal oxide layer.

19. The method according to claim 18, wherein forming the metal oxide layer utilizes ion beam deposition.

20. The method according to claim 18, wherein the metal layer is a chromium metal layer and the metal oxide layer is a chromium oxide layer.
